(19) United States
(12) Patent Application Publication
(10) Pub. No.: US 2022/0080931 A1
(43) Pub. Date: Mar. 17, 2022

(54) Automatic Trailer Wash

(71) Applicant: Michael Roy Shinsky, Venice, FL (US)

(72) Inventor: Michael Roy Shinsky, Venice, FL (US)

(21) Appl. No.: 17/387,567

(22) Filed: Jul. 28, 2021

Related U.S. Application Data
(60) Provisional application No. 63/079,098, filed on Sep. 16, 2020.

(51) Int. Cl. B60S 1/66; B60R 15/02

(52) U.S. Cl. CPC B60S 1/66; B60R 15/02

(57) ABSTRACT

The present invention provides a washing device designed to provide a means of washing a trailer. The washing device comprises a plurality of water tanks, a control member having a substantially triangular shape, the control member attached to the water tanks, and a connecting bar connected to the tanks.

The current application claims a priority to the U.S. provisional patent application Ser. No. 63/079,098 filed on Sep. 16, 2020.

### FIELD OF THE INVENTION

The present invention generally relates to washing devices. More specifically, the present invention relates to a device designed for washing trailers.

### BACKGROUND OF THE INVENTION

A device designed for washing trailers is in demand. Marine trailers, especially in a saline environment, are quickly corroded by normal use. A boat trailer usually features beam construction and is made of galvanized steel or aluminum. Its axles, springs, and hubs are prone to failure as a result of corrosion, risking serious damage to the boat. The beams, particularly if made of aluminum, long outlast the other components, being made of a corrosion-resistant material.

Many boat owners operating in a saline environment are conscientious of their trailer's components and devote considerable time and effort to ensuring that these components last by washing their trailer's hubs, springs, and axles. Many also try to prevent the spread of aquatic invasive species by using hot and/or high-pressure water to clean their boat.

To use a boat, it must be floated into the water from its trailer and then back onto the trailer for fastening thereon. After having been backed into the water and then returned to land, the trailer may be coated with saltwater and aquatic invasive species, which may have a detrimental effect on the trailer. Accordingly, it is important to clean a trailer after immersing it.

Car washes may be used for this purpose, but not all boat owners may be near a car wash, and in any case the wash must offer the option to self-operate a high-pressure hose.

What's more, boaters generally do not have access to a wash station at the boat ramp, where the trailer is exposed to saltwater longest. After boaters offload their boat into the water by submerging the trailer, they then park the trailer in the parking lot for the day, unable to wash its components until later.

Typically, the trailer sits 3-6 hours or more before the boat owner returns, only to resubmerge it and load the boat. By the time the boat owner can take trailer and boat to be washed, corrosion has had hours to set in. Boat ramps are often busy, and limited docking and parking space would prevent boat owners from washing their trailers even if they had the means to. Thus, there is a need to develop a device to solve the problems.

The present invention is intended to address problems associated with and/or otherwise improve on conventional devices through an innovative washing device that is designed to provide a convenient means of cleaning a trailer while incorporating other problem-solving features.

### SUMMARY

In accordance with the present invention, a washing device is provided that requires a plurality of water tanks, a control member attached to the water tanks, and a connecting bar connected to the tanks. The present invention is designed to prolong the lives of trailer axles, hubs, and springs. The washing device of the present invention can be affixed without drilling or modification to a trailer.

In one embodiment, the washing device includes storage tanks that can be slid over the I-beam of the trailer on either side.

In another embodiment, the electronic controller includes a plurality of buttons and electronic circuits to power the pump on and off and operate it. The water pressure of the pump can be adjusted to up to a suitable level and the pump can be connected to and activated by a towing vehicle's power source.

In yet another embodiment, the present invention includes a locking system to secure the washing device to the trailer.

### BRIEF DESCRIPTION OF THE DRAWINGS

FIG. 1 is an illustration of one embodiment of the present invention.

FIG. 2 is an illustration of one embodiment of the present invention installed on a boat trailer.

FIG. 3 is a top side rear view of one embodiment of the present invention showing the cross-sectional view of the tanks.

FIG. 4 is a top side rear view of one embodiment of the present invention showing the cross-sectional view of the tanks with the connecting bar.

FIG. 5 is an illustration of one embodiment of the control member of the present invention.

### DETAIL DESCRIPTIONS OF THE INVENTION

All illustrations of the drawings are for the purpose of describing selected versions of the present invention and are not intended to limit the scope of the present invention.

The present invention provides a device (“automatic trailer wash”) that is designed to provide a means of washing a trailer at the push of a button. This device uses liquid storage tanks, a battery, a pump, and a controller to push water through tubing, affixed by clips, to the areas of the springs, hubs, and axles.

The hoses have nozzles affixed to their end and may be adjusted to spray desired locations. In addition, the present invention has electrical connections allowing the trailer lights to be plugged into the electronics module, with another cable then connecting it to the female trailer harness.

The automatic trailer wash is designed to prolong the lives of trailer axles, hubs, and springs by allowing the owner to wash the trailer's components immediately after submerging them, without taking valuable time at the boat ramp.

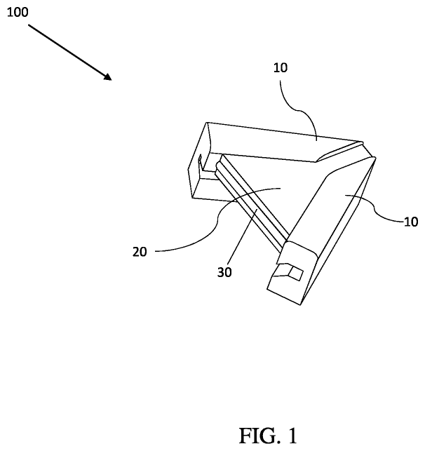

As shown in FIG. 1, the present invention provides a washing device 100 that comprises a plurality of tanks 10, a control member 20, and one or more connecting bars 30. The connecting bar 30 is designed to connect the tanks 10, and the control member 20 can be attached to a suitable place on the connecting bar 30.

The tanks 10 can be of any shape, size, and material suitable for carrying sufficient water to wash the trailer 40. Such suitable materials may include plastic or aluminum.

The tanks 10 may include an opening or a means of connecting a hose that may have a nozzle attached at one end.

In some embodiments, the tanks 10 can include a filler cap and connecting tubes that connect to the pump included in the control member.

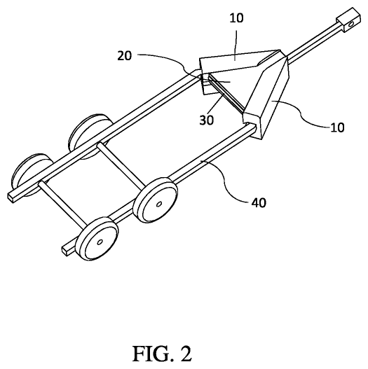

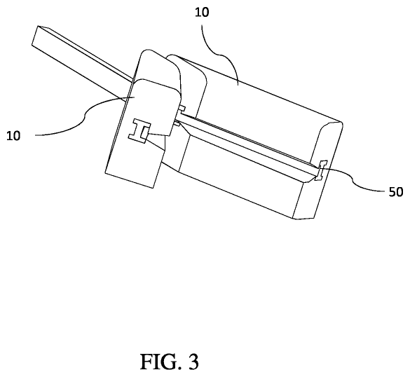

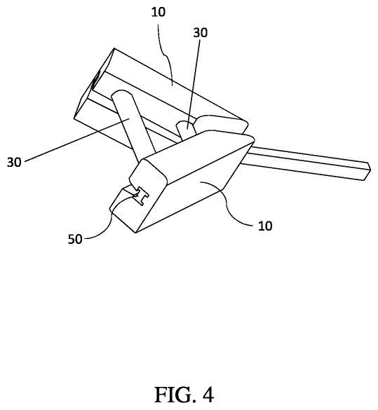

In preferred embodiments, the washing device 100 includes two storage tanks 10 that are shaped to slide over the I-beam 50 of the trailer 40 on either side, connected by the connecting bar 30, as shown in FIGS. 2 to 4.

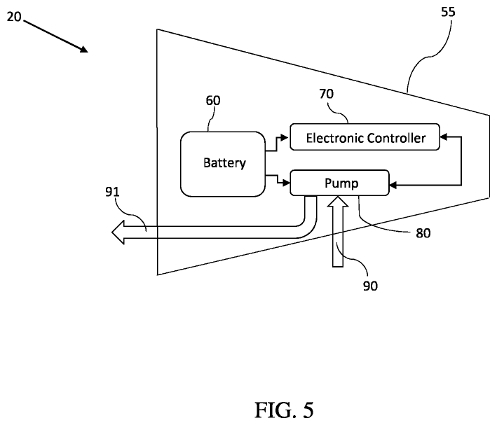

The control member 20, as shown in FIG. 5, may include a pump 80; an electronic controller 70; a battery 60; and a housing 55, which may be watertight and of suitable size and design to seal the pump 80, the electronic controller 70, and the battery 60, which are connected to one another to provide a means of controlling the pump 80 receiving water 90 from the tank 10 and delivering water 91 to the outside of the housing 55 when the pump 80 is activated.

The electronic controller 70 may include a plurality of buttons and electronic circuits to power the pump 80 on and off and operate it.

The pump 80 may be designed to deliver water pressure to up to a suitable level so as to produce the desired cleaning results. The pump 80 may be connected to and powered by the battery 60; alternatively, it may be connected to and activated by a towing vehicle's power source.

In some embodiments, the control member 20 may include a locking system to secure the washing device to the trailer.

The connecting bar 30 can of any shape, size, and material, such as metal, suitable for supporting the tanks 10 when installed on the trailer 40.

In some embodiments, the connecting bars 30 can be one or more connecting bars 30 designed to extend from one tank 10 to the other over the trailer's I-beam 50 and through the control member 20 in such a way that the two tanks 10 can be sitting on either side of the I-beam 50 and the control member 20 can be placed substantially in the central area of the connecting bar 30.

Any fasteners known in the art can be used to secure the tanks 10 to the trailer 40, traveling through the housing 55 of the control member 20 to pull them toward each other while locking them in position.

The washing device 100 of the present invention can be used with any hose of the desired length, which may include one or more nozzles at one end, opposite another end connected to one or more tanks 10.

The design of the present invention may allow the washing device 100 of the present invention to be affixed without drilling or modification to the trailer 40 and may allow use on a variety of sizes and brands of trailers 40.

In certain other embodiments, the washing device 100 of the present invention may further include components placed on the washing device 100 in positions suitable for providing additional features, including an electric trailer jack, an electric trailer winch, a telescoping motor flusher, a GPS tracking module, a solar charger, an air compressor, a wireless connection to a smartphone, and a tool compartment.

Although the invention has been explained in relation to its preferred embodiment, it is to be understood that many other possible modifications and variations can be made without departing from the spirit and scope of the invention.

What is claimed is:

1. A washing device comprising
a plurality of tanks;
a control member having a substantially triangular shape; the control member attached to the tanks; and
a connecting bar connected to the tanks.

2. The washing device as claimed in claim 1, wherein control member includes a housing, a pump placed inside the housing and receiving water from the tank and delivering water the outside of the housing when activated, a battery connected to the pump, and an electronic controller connected to the pump.

3. The washing device as claimed in claim 1, wherein the tank includes a groove to attach the control member.

4. The washing device as claimed in 1 includes two tanks that are shaped to slidingly attached to a trailer.

5. The washing device as claimed in claim 1, wherein the control member is placed on top of the connecting bar.

6. The washing device as claimed in claim 2, wherein the tank includes a filler cap and connecting tubes that connect to the pump.

7. The washing device as claimed in claim 1, wherein the control member includes a plurality of buttons and electronic circuits.
